(19) United States
(12) Patent Application Publication
(10) Pub. No.: US 2003/0069989 A1
(43) Pub. Date: Apr. 10, 2003

(54) Extending bluetooth personal area networks

(76) Inventor: Kelan C. Silvester, Portland, OR (US)

Correspondence Address: Timothy N. Trop, TROP, PRUNER & HU, P.C., 8554 KATY FWY, STE 100, HOUSTON, TX, 77024-1805, US

(21) Appl. No.: 09/972,273

(22) Filed: Oct. 5, 2001

(51) Int. Cl. G06F 15/173

(52) U.S. Cl. 709/238; 709/245

(57) ABSTRACT

The range and number of devices in a Bluetooth piconet may be extended by providing local area network functionality. A master device in a given piconet may receive a communication and may determine whether the intended endpoint of the communication is within the same piconet as the master device. If not, the data may be forwarded to another piconet and the same procedure may be implemented to determine whether or not the endpoint is within the receiving piconet. As a result, a local area network of extended range and device capacities may be created in an ad hoc fashion.

### BACKGROUND

This invention relates generally to networks of processor-based devices communicating with one another using the Bluetooth wireless protocol (Specification of the Bluetooth System, Version 1.1, Feb. 22, 2001).

The Bluetooth wireless protocol enables processor-based devices to communicate with one another at distances of up to ten meters, using the 2.4 gigahertz Instrumentation Scientific and Medical Band. A small ad hoc network of up to seven devices may be formed within a ten meter space in what may be called a Bluetooth personal area network (PAN).

A Bluetooth piconet may be formed between any two Bluetooth devices engaging in a radio frequency discovery procedure. Thus, two or more Bluetooth devices linked on the same frequency hopping sequence may be considered to be a Bluetooth piconet. Generally, the discovered device becomes the slave device, while the discoverer becomes the master. The master is the device designated as the router on the piconet. The slave device is any device not acting as the router on the piconet. Thus, in a master/slave piconet, a single device is designated the master and all other devices assume the role of slave devices.

A master polls a slave device by addressing a packet to the slave device before a slave device can transmit. All communications are either master-to-slave or slave-to-master. Since all communications in a master/slave piconet are between the master and the slave, the master effectively becomes the router.

A scatternet is three or more Bluetooth devices linked on at least two frequency hopping sequences. A device may be a slave on all sequences or a master on one and a slave on another.

Unfortunately, the reach of a Bluetooth personal area network is limited to approximately ten meters and about seven devices.

Thus, it would be desirable to enable the number of devices and the geographic reach of such networks to be extended.

### BRIEF DESCRIPTION OF THE DRAWINGS

FIG. 1 is a schematic depiction of one embodiment of the present invention;

FIG. 2 is a schematic depiction of master/slave pair in accordance with one embodiment of the present invention; and

FIG. 3 is a flow chart for software in accordance with one embodiment of the present invention.

### DETAILED DESCRIPTION

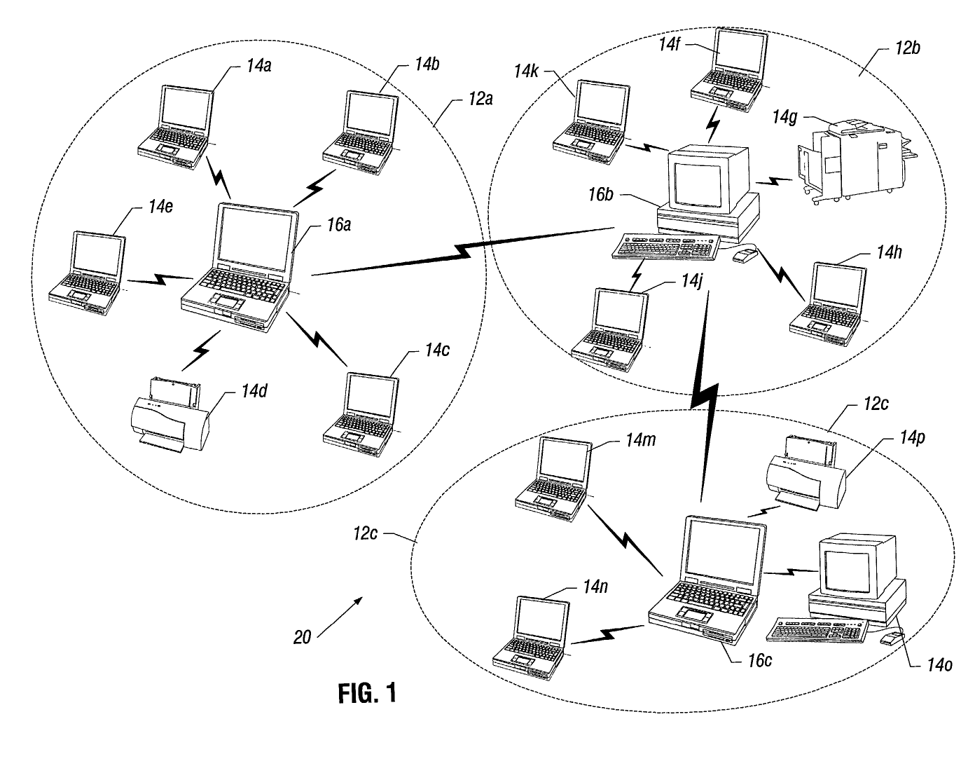

Referring to FIG. 1, each of a plurality of piconets 12 may include a master device 16 and a plurality of slave devices 14.

In a conventional Bluetooth piconet, the devices in one piconet do not necessarily communicate in a networked fashion with any of the devices in another piconet. Thus, the range of each piconet is generally limited to the range of the Bluetooth protocol. Also, the number of devices accommodated under the Bluetooth protocol (seven) limits the number of devices available to devices within any one piconet.

However, by making the master device 16 of each piconet 12 able to function as a server, the piconets 12a, 12b, and 12c may be wirelessly coupled to one another extending the range of each piconet 12 and the number of devices addressable by devices 14, 16 in each piconet 12.

In particular, the master device 16a of the piconet 12a may communicate with the master device 16b of the piconet 12b so long as the master devices 16a and 16b happen to be within ten meters of one another. Similarly, the master device 16b may communicate with the master device 16c of the piconet 12c if those devices 16b, 16c are within range of one another. Moreover, the device 16a may communicate with slaves 14m, 14n, 14o, and 14p in the piconet 12c via the master device 16b in the in-range piconet 12b. As a result, the range of the master device 16 in each piconet 12 can effectively be extended and the number of resources available to all the devices 14, 16 in each piconet 12 are also similarly extended. Since the range of the master device 16 is extended, the effective range of the devices 14 slaved to master device 16 is also extended.

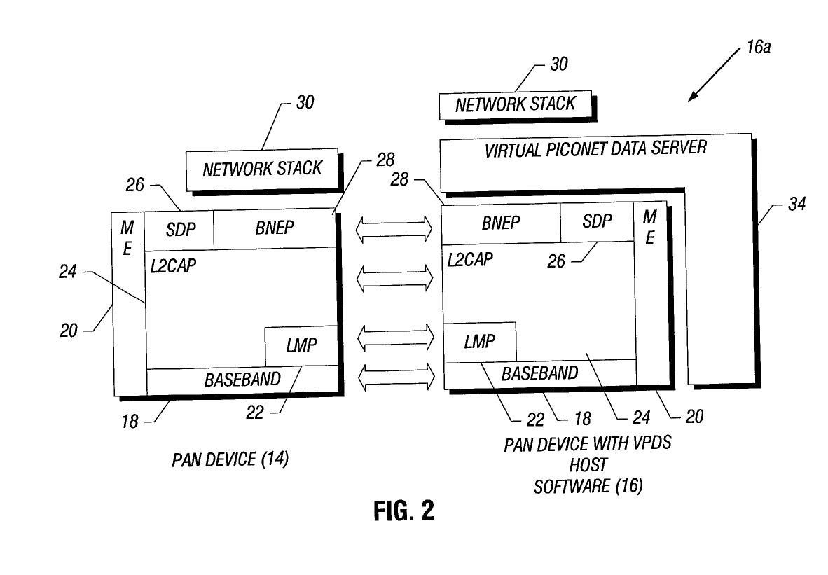

Referring to FIG. 2, each slave device 14 may include a network stack 30, a management entity (ME) 20, and a Logical Link Control and Adaptation Protocol (L2CAP) 24. A baseband layer 18 may be below a Link Manager Protocol (LMP) 22. In addition, a Bluetooth Network Encapsulation Protocol (BNEP) layer 28 may be provided for implementing the PAN profile. A service discovery protocol (SDP) 26 may also be present. Thus, the configuration of the slave device 14 may be conventional in all respects in some embodiments.

In some embodiments, the master device 16 may be similar in all respects to the slave device 14 with the exception of the addition of the virtual piconet data server 34. The virtual piconet data server 34 enables the master device 16 to determine whether the endpoint for a given wireless communication is within the piconet 12 occupied by that master device 16. If the endpoint is not within that piconet 12, the master device 16 sends the communication to at least one proximate piconet 12, such as the piconet 12b in FIG. 1.

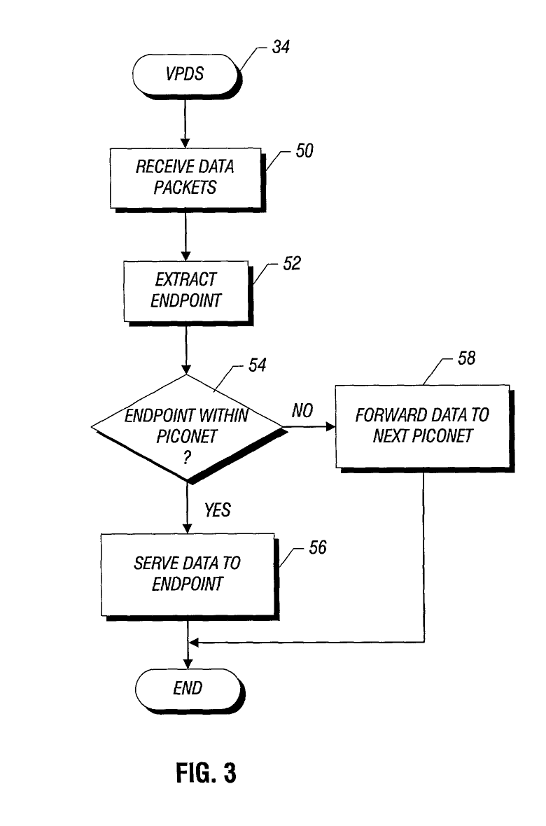

Referring to FIG. 3, the operation of the virtual piconet data server 34 begins by receiving data packets, as indicated in block 50, that need to be communicated to an endpoint that may be within the same piconet 12 as the master device 16 (or not). The endpoint or destination for the packets is extracted, as indicated in block 52. A check at diamond 54 determines whether the extracted endpoint is within the same piconet 12 as the master device 16. If so, the master device 16 merely serves the data to the intended endpoint, as indicated in block 56.

If the endpoint is not within the piconet 12 of the master device 16, then the data may be forwarded to at least one in-range piconet 12 in one embodiment. In one embodiment, the data may be forwarded to a pre-assigned in-range piconet 12, as indicated in block 58. In another embodiment, the data may be forwarded to all in-range piconets 12. The data is then handled within each receiving piconet 12 pursuant to the same procedural flow just described.

However, data need not be forwarded from piconet 12 to piconet 12 and back again. Standard network forwarding schemes may be utilized to determine if a specific data packet has already been inspected and forwarded by a given piconet 12 previously. If the data has been inspected and forwarded by a given piconet 12, that piconet 12 does not forward the data again.

As a result, each virtual piconet data server 34 propagates data within an extended local area network (LAN) in order to achieve a local area network larger than the ten meter range of any single Bluetooth PAN. Adjacent Bluetooth PANs can be stretched across an office or university campus with no limit on range from end to end so long as adjacent PANs are within range of each other. In other words, the data may be transferred “bucket brigade” style from one in-range piconet 12 to another in-range piconet 12, ending up in piconets 12 that may be far outside the range of the initiating piconet 12.

The functionality of the virtual piconet data server 34 in propagating data between adjacent PANs to achieve a local area network functionality may be made dynamic so that if the virtual piconet data server 34 moves outside an existing PAN, another PAN node can detect the movement and dynamically assert itself to be the new virtual piconet data server 34. For example, if a notebook computer is acting as the master device 16 and providing virtual piconet data server 34 capabilities, when that notebook moves outside the piconet 12, another Bluetooth device, presumably a slave device 14 can negotiate to become the new virtual piconet data server 34 of a particular piconet 12.

Addresses of master and slave devices 14 and 16 may be assigned as specified in the PAN definitions. No changes in device addressing may be necessitated in some embodiments.

As a result, small-scale local area networks can be constructed without the need to supply expensive and complex server hardware and software. Adding the Bluetooth local area network functionality to notebook computers, for example, provides everything necessary to create an on-the-spot local area network using Bluetooth enabled devices.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing data to a Bluetooth piconet;
determining whether the intended endpoint of the data is within the piconet; and
if the intended endpoint is not within the piconet, wirelessly forwarding the data to another piconet.

2. The method of claim 1 including establishing a piconet including a master device and one or more slave devices.

3. The method of claim 2 including providing at least the master device with software to enable the master device to determine whether the intended endpoint of the data is within the piconet and, if the intended endpoint of the data is not within the piconet, wirelessly forward the data to another piconet.

4. The method of claim 3 including enabling any device within the piconet to assume the role of master device when a previous master device moves out of range of the piconet.

5. The method of claim 1 including preventing data from being received again by a piconet that previously forwarded the data on to another piconet.

6. An article comprising a medium storing instructions that enable a processor-based system to:
provide data to a Bluetooth piconet;
determine whether the intended endpoint of the data is within the piconet; and
if the intended endpoint is not within the piconet, wirelessly forward the data to another piconet.

7. The article of claim 6 further storing instructions that enable the processor-based system to establish a piconet that includes a master device and one or more slave devices.

8. The article of claim 7 further storing instructions that enable the processor-based system to enable any device within the piconet to assume the role of master device when a previous master device moves out of range of the piconet.

9. The article of claim 6 further storing instructions that enable the processor-based system to prevent data from being received again by a piconet that previously forwarded the data on to another piconet.

10. A system comprising:
a processor; and
a storage coupled to said processor storing instructions that enable the processor to:
provide data to a Bluetooth piconet;
determine whether the intended endpoint of the data is within the piconet; and
if the intended endpoint is not within the piconet, wirelessly forward the data to another piconet.

11. The system of claim 10 wherein said storage stores instructions that enable the processor to establish a piconet that includes a master device and one or more slave devices.

12. The system of claim 11 wherein said storage stores instructions that enable the processor to enable any device within the piconet to assume the role of master device when a previous master device moves out of range of the piconet.

13. The system of claim 10 wherein said storage stores instructions that enable the processor to prevent data from being received again by a piconet that previously forwarded the data on to another piconet.

14. The system of claim 10 including a wireless transceiver.

15. The system of claim 14 including a Bluetooth wireless transceiver.
